(19) United States
(12) Patent Application Publication
(10) Pub. No.: US 2026/0323197 A1
(43) Pub. Date: Oct. 15, 2026

(54) MEASUREMENT DEVICE AND MEASUREMENT SYSTEM

(71) Applicant: SONY GROUP CORPORATION, TOKYO (JP)

(72) Inventors: RYUTARO WATANABE, TOKYO (JP); HIRONORI SATOU, TOKYO (JP); TOMOHIRO KUBO, TOKYO (JP)

(21) Appl. No.: 19/485,842

(22) PCT Filed: May 8, 2024
(86) PCT No.: PCT/JP2024/017031

§ 371 Date: Nov. 19, 2025

(30) Foreign Application Priority Data
Jun. 5, 2023 (JP) 2023-092683

(51) Int. Cl. H04R 1/08; F16M 11/20; G01B 11/00; G01B 11/27; G01H 3/00; H04R 1/40

(52) U.S. Cl. CPC H04R 1/083; F16M 11/205; G01B 11/002; G01B 11/272; H04R 1/406; G01H 3/00; H04R 2201/401

(57) ABSTRACT

To change the position and orientation of a microphone with a high degree of freedom and to suppress the influence of a structure on acoustic measurement. The measurement device is a measurement device for performing acoustic measurement, and includes one or more microphones configured to acquire sound output from a sound source at a sound receiving point; a first support which directly or indirectly supports the one or more microphones such that the sound receiving point is located at a rotation center or in the air at a predetermined distance from the rotation center; a second support which supports the first support at a lower end of the first support; a first motor configured to rotate the first support in a vertical direction; and a second motor configured to rotate the second support in a horizontal direction.

### TECHNICAL FIELD

The present invention relates to a measurement device and a measurement system.

### BACKGROUND ART

There is a known technique for performing acoustic measurement by moving and rotating one or more microphones to a plurality of positions and orientations, installing the one or more microphones at certain positions, reproducing measurement signals one by one, and picking up sound to acquire a measurement result such as a room impulse response (RIR). For example, there is a known technique for performing acoustic measurement at sound receiving points in a plurality of directions from one microphone having only one sound receiving point by changing the orientation of the microphone (for example, see PTLs 1 to 3). A technique for performing acoustic measurement at a plurality of positions where sound receiving points of a microphone are at a constant distance from a rotation axis is known (for example, see PTL 2).

### CITATION LIST

### Patent Literature

PTL 1: JP 2005-69774 A

PTL 2: JP 2008-249702 A

PTL 3: JP 2019-161455 A

### SUMMARY

### Technical Problem

However, in the above-described technique in the related art, the position and orientation of the microphone cannot be changed with a high degree of freedom, and the influence of the structure on the acoustic measurement cannot be suppressed in some cases. For example, in the related art, the degree of freedom of the position and orientation of the microphone is limited, for example, it is impossible to set the sound receiving point of the microphone near the rotation center. Additionally, the acoustic measurement and the measurement result are adversely affected by reflection, diffraction, and the like of structures in the measurement device itself around the microphone in some cases. One aspect of the present disclosure enables the position and orientation of a microphone to be changed with a high degree of freedom, and enables the influence of a structure on acoustic measurement to be suppressed.

### Solution to Problem

A measurement device according to an aspect of the present disclosure is a measurement device for performing an acoustic measurement, including one or more microphones configured to acquire sound output from a sound source at a sound receiving point; a first support which directly or indirectly supports the one or more microphones such that the sound receiving point is located at a rotation center or in the air at a predetermined distance from the rotation center; a second support which supports the first support at a lower end of the first support; a first motor configured to rotate the first support in a vertical direction; and a second motor configured to rotate the second support in a horizontal direction.

A measurement system according to an aspect of the present disclosure is a measurement system for performing an acoustic measurement, including a measurement device; and an information processing device, the measurement device including: one or more microphones configured to acquire sound output from a sound source at a sound receiving point; a first support which directly or indirectly supports the one or more microphones such that the sound receiving point is located at a rotation center or in the air at a predetermined distance from the rotation center; a second support which supports the first support at a lower end of the first support; a first motor configured to rotate the first support in a vertical direction; and a second motor configured to rotate the second support in a horizontal direction, and the information processing device including an output control unit configured to cause the sound source to output the sound.

### BRIEF DESCRIPTION OF DRAWINGS

FIG. 1 is a side view illustrating an example of a measurement device according to a first embodiment.

FIG. 2 is a side view illustrating an example of a microphone and a measurement section.

FIG. 3 is a diagram for explaining an example of a measurement device according to the first embodiment.

FIG. 4 is a diagram for explaining an example of the measurement device according to the first embodiment.

FIG. 5 is a top view illustrating an example of the measurement device according to the first embodiment.

FIG. 6 is a side view illustrating an example of the measurement device according to the first embodiment.

FIG. 7 is a side view illustrating an example of the measurement device according to the first embodiment.

FIG. 8 is a schematic view illustrating an example of a measurement device according to a second embodiment.

FIG. 9 is a schematic view illustrating an example of a measurement device according to a third embodiment.

FIG. 10 is a schematic view illustrating an example of a measurement device according to a fourth embodiment.

FIG. 11 is a block diagram illustrating an example of a measurement system according to a fifth embodiment.

FIG. 12 is a flowchart illustrating an example of a measurement process performed by the measurement system according to the fifth embodiment.

FIG. 13 is a block diagram illustrating an example of a measurement system according to a sixth embodiment.

FIG. 14 is a diagram for explaining an example of display control.

FIG. 15 is a block diagram illustrating an example of a measurement system according to a seventh embodiment.

FIG. 16 is a diagram for explaining an example of transmission of measurement information.

FIG. 17 is a block diagram illustrating an example of a measurement system according to an eighth embodiment.

FIG. 18 is a block diagram illustrating an example of a measurement system according to a ninth embodiment.

FIG. 19 is a diagram for explaining an example of estimation of a measurement result.

FIG. 20 is a block diagram illustrating an example of a hardware configuration of a device.

### DESCRIPTION OF EMBODIMENTS

Hereinafter, embodiments of the present disclosure will be described in detail with reference to the drawings. In the following embodiments, the same elements are denoted by the same reference numerals, and redundant description may be omitted.

The present disclosure will be described in the following order.
0. Introduction
1. First Embodiment
2. Modification
3. Second Embodiment
4. Third Embodiment
5. Fourth Embodiment
6. Fifth Embodiment
7. Modification
8. Sixth Embodiment
9. Seventh Embodiment
10. Eighth Embodiment
11. Ninth Embodiment
12. Example of Hardware Configuration
13. Example of Effect

### 0. Introduction

As described above, in the techniques in the related art such as those of PTLs 1 to 3, the position and orientation of the microphone cannot be changed with a high degree of freedom, and the influence of the structure on the acoustic measurement cannot be suppressed in some cases. For example, in the related art, the degree of freedom of the position and orientation of the microphone is limited, for example, it is impossible to set the sound receiving point of the microphone near the rotation center. Additionally, the acoustic measurement and the measurement result are adversely affected by reflection, diffraction, and the like of structures in the measurement device itself around the microphone in some cases.

According to the technique of the present disclosure, the position and orientation of the microphone can be changed with a high degree of freedom, and the influence of the structure on the acoustic measurement can be suppressed.

Specific techniques will be described in the embodiments described later.

### 1. First Embodiment

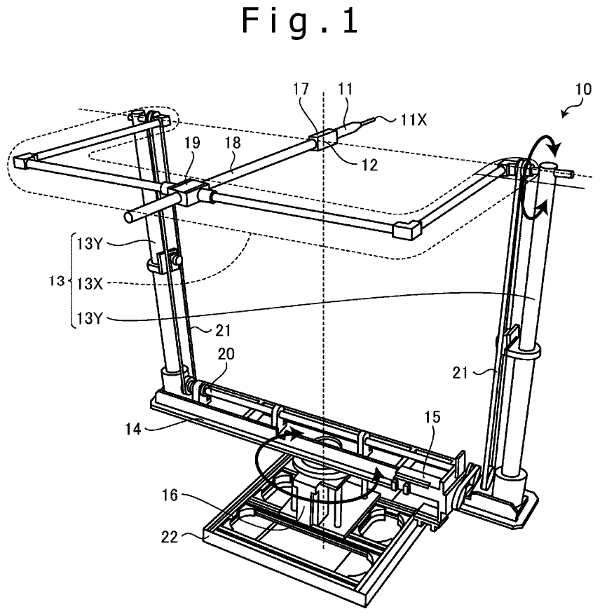

FIG. 1 is a side view illustrating an example of a measurement device according to the first embodiment. A measurement device 10 is a device for performing acoustic measurement. Here, acoustic measurement refers to installing a microphone at a certain position, reproducing measurement signals one by one, and picking up sound. As illustrated in FIG. 1, the measurement device 10 includes a microphone 11, a first support 13, a second support 14, a first motor 15, and a second motor 16. As illustrated in FIG. 1, the measurement device 10 may further include a measurement section 17, a boom 18, and a third motor 19. In the example illustrated in FIG. 1, the measurement device 10 includes only one microphone 11, but may include a plurality of microphones 11.

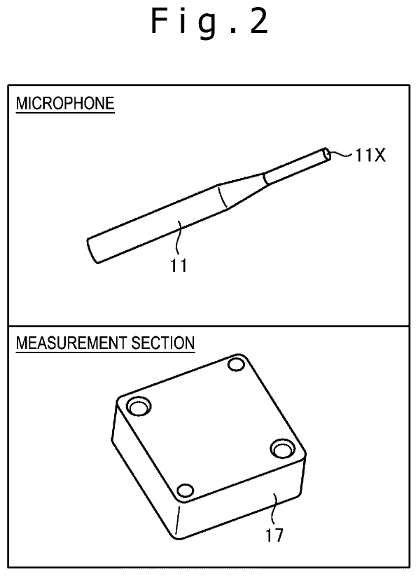

The microphone 11 acquires sound output from a sound source at a sound receiving point 11X. For example, the microphone 11 records sound output from the speaker at the sound receiving point 11X. Hereinafter, an example of the microphone 11 will be described with reference to FIG. 2. FIG. 2 is a side view illustrating an example of a microphone and a measurement section. As illustrated in FIG. 2, examples of the microphone 11 include a stick-type directional microphone.

In the examples illustrated in the diagrams of the microphones in FIGS. 1 and 2, the microphone 11 is a stick-type directional microphone having the sound receiving point 11X provided at an end thereof, but is not particularly limited as long as the microphone 11 can acquire sound output from a sound source at the sound receiving point 11X. For example, the microphone 11 may be a directional microphone or a non-directional microphone. The shape of the microphone 11 is not particularly limited, and may be, for example, a stick-type microphone as described above, or a spherical microphone. Examples of the stick-type microphone include microphones illustrated in FIGS. 1 and 2, and a gun microphone. The position of the sound receiving point of the gun microphone is not particularly limited, and examples thereof include the base of the microphone 11, and the vicinity of a connection portion (a connection terminal, a connector, or the like) where the microphone 11 is directly or indirectly connected to the first support 13. The spherical microphone is not particularly limited, and examples thereof include a spherical array microphone in which a plurality of microphones are installed in one housing.

The first support 13 directly or indirectly supports the microphone 11 such that the sound receiving point 11X is located at a rotation center 12 or in the air at a predetermined distance from the rotation center 12. The first support 13 may directly or indirectly support the microphone 11 such that the sound receiving point 11X is located at the rotation center 12, or may directly or indirectly support the microphone 11 such that the sound receiving point 11X is located in the air at a predetermined distance from the rotation center 12. The rotation center 12 refers to, for example, an intersection of the rotation axis of the first support 13 and the rotation axis of the second support 14 as illustrated in FIG. 1.

In the example illustrated in FIG. 1, the first support 13 indirectly supports the microphone 11 via the boom 18 so that the sound receiving point 11X is located in the air at a predetermined distance from the rotation center 12. However, the first support 13 may directly support the microphone 11. For example, the first support 13 may be connected to the microphone 11 at an end of the microphone 11 on the side opposite to the sound receiving point 11X, thereby directly supporting the microphone 11.

In the example illustrated in FIG. 1, the first support 13 includes a U-shaped support 13X (a swing-type support) and two columnar supports 13Y. The U-shaped support 13X directly or indirectly supports the microphone 11 at the bottom of the U-shaped support 13X.

For example, the U-shaped support 13X indirectly supports the microphone 11 at the bottom of the U-shaped support 13X via the boom 18. In the example illustrated in FIG. 1, the U-shaped support 13X indirectly supports the microphone 11 at the bottom of the U-shaped support 13X by supporting the boom 18 connected to the end of the microphone 11 on the side opposite to the sound receiving point 11X at the bottom of the U-shaped support 13X. The two columnar supports 13Y lock each upper end of the U-shaped support 13X in a state where the U-shaped support 13X is rotatable in accordance with the power transmitted from the first motor 15.

The U-shaped support 13X may directly or indirectly support the microphone 11 at the bottom so that the distance between the sound receiving point 11X and each of the two columnar supports 13Y is equal to or greater than a predetermined threshold. The predetermined threshold is not particularly limited as long as the sound receiving point 11X is separated from the surrounding structures such as the two columnar supports 13Y to the extent that the influence of the structures is not easily received where, for example, the influence of the reflection of the sound by the structures is reduced, but may be, for example, 50 cm or the like. In the example illustrated in FIG. 1, the U-shaped support 13X indirectly supports the microphone 11 at the approximate center of the bottom so that the distance from the rotation center 12 to each of the two columnar supports 13Y is 50 cm or more. Here, in the example illustrated in FIG. 1, the distance from the sound receiving point 11X to each of the two columnar supports 13Y is longer than the distance from the rotation center 12 to each of the two columnar supports 13Y. As a result, the U-shaped support 13X indirectly supports the microphone 11 at the bottom so that the distance between the sound receiving point 11X and each of the two columnar supports 13Y is 50 cm or more.

The second support 14 supports the first support 13 at the lower end of the first support 13. For example, as illustrated in FIG. 1, the second support 14 supports the first support 13 at the lower ends of the two columnar supports 13Y in the vertical direction of the first support 13.

The first motor 15 rotates the first support 13 in the vertical direction. The second motor 16 rotates the second support 14 in the horizontal direction. For example, as illustrated in FIG. 1, the first motor 15 rotates the U-shaped support 13X in any of the directions of the elliptic arrows whose longitudinal directions are vertical, and the second motor 16 rotates the second support 14 in any of the directions of the elliptic arrows whose longitudinal directions are horizontal.

As illustrated in FIG. 1, at least one of the first motor 15 or the second motor 16 may be installed at a position adjacent to the second support 14. For example, the first motor 15 is installed inside a housing connected to the second support 14, and the second motor 16 is installed on a pedestal 22 below the second support 14.

Here, since the second support 14 supports the first support 13 at the lower end of the first support 13, the second support 14 is installed below the microphone 11 that is installed above the lower end of the first support 13. In the example in FIG. 1, the first motor 15 and the second motor 16 are installed at the same position as or below the second support 14 in the vertical direction, and as a result, are installed below the microphone 11 that is installed above the second support 14.

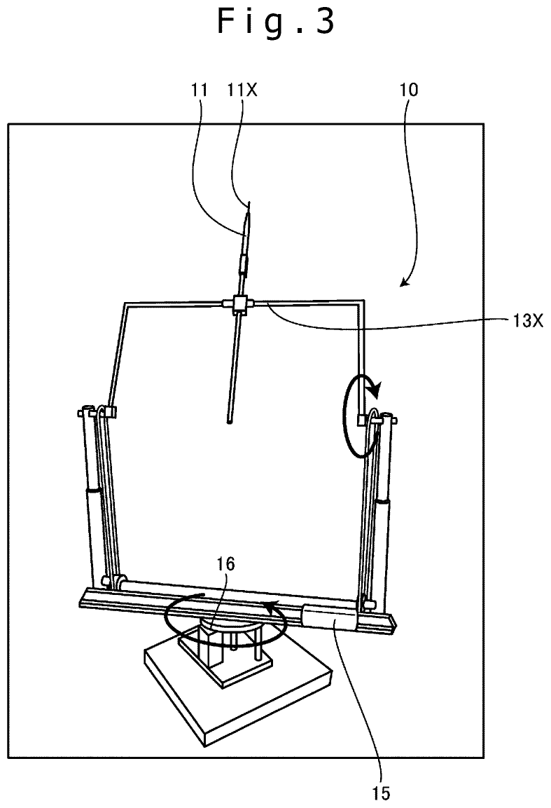

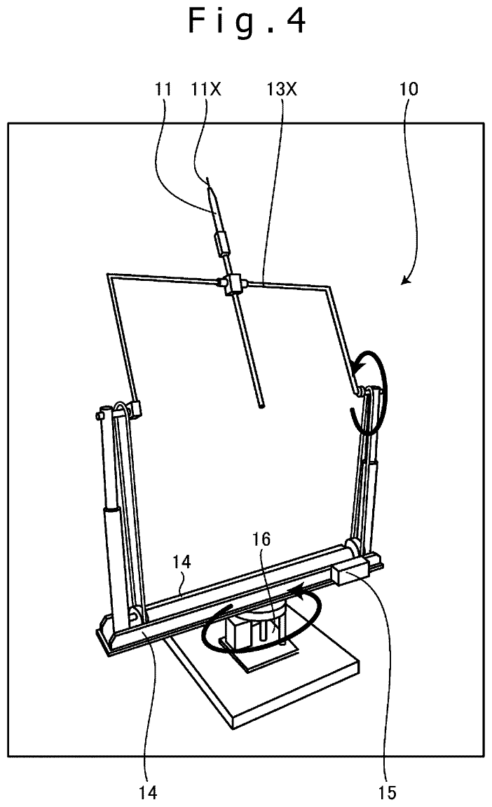

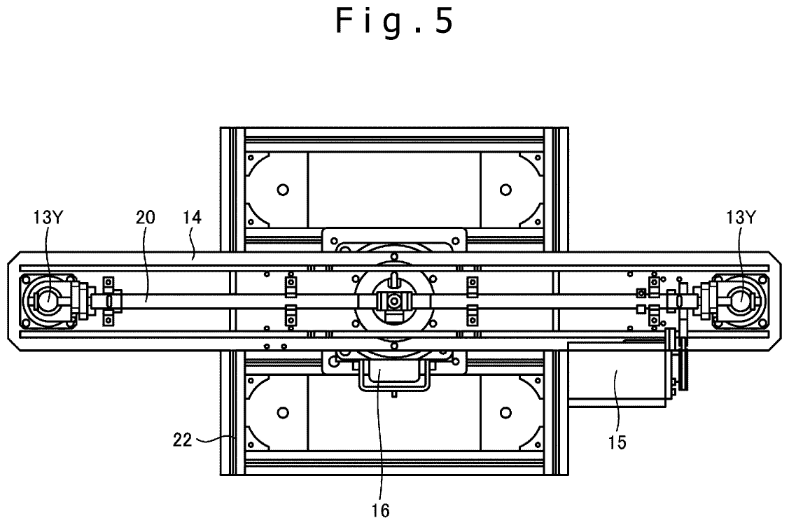

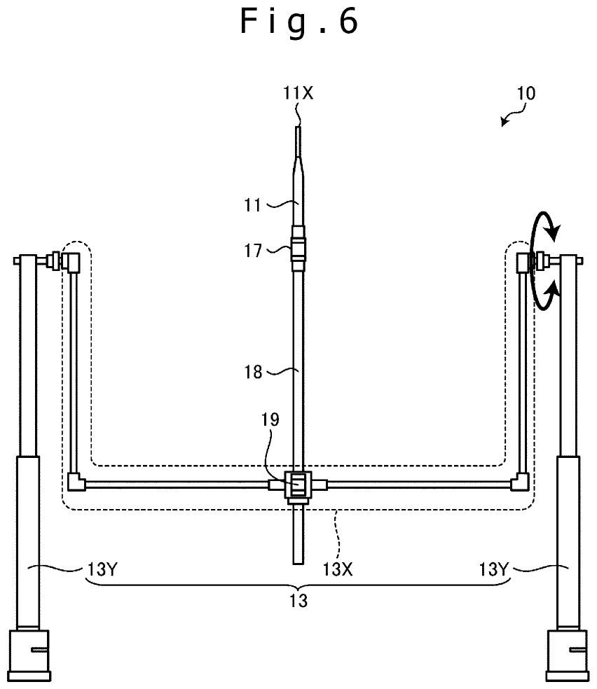

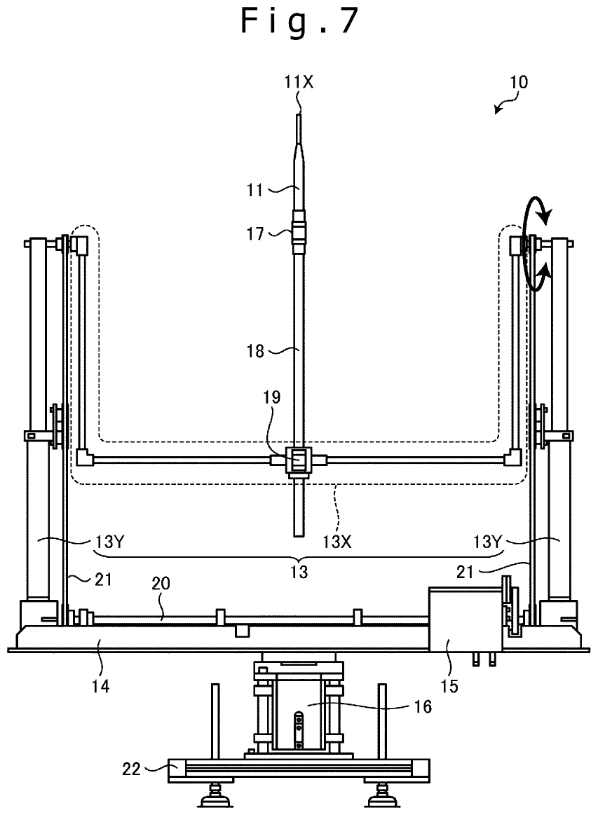

Hereinafter, an example of the first motor 15 and the second motor 16 will be described in detail with reference to FIGS. 3 to 6. FIGS. 3 and 4 are diagrams for explaining an example of the measurement device according to the first embodiment. FIG. 5 is a top view illustrating an example of the measurement device according to the first embodiment. FIGS. 6 and 7 are side views illustrating an example of the measurement device according to the first embodiment. The shape of the measurement device 10 illustrated in FIGS. 3 to 6 does not necessarily match the shape of the measurement device 10 illustrated in FIG. 1, but members having the same functions are denoted by the same reference numerals. As described above, the measurement device 10 can have any shape as long as the measurement device 10 includes members having the same functions.

FIGS. 3 and 4 are also diagrams illustrating the rotational operation of the U-shaped support 13X and the second support 14 of the measurement device 10, in which the shape of the measurement device 10 illustrated in FIG. 1 is simplified. In the example illustrated in FIGS. 3 and 4, the first motor 15 rotates the U-shaped support 13X of the first support 13 in the direction of an elliptical arrow whose longitudinal direction is vertical. The second motor 16 rotates the second support 14 in the direction of an elliptical arrow whose longitudinal direction is horizontal. As a result, the position and orientation of the sound receiving point 11X of the microphone 11 are changed from the position and orientation illustrated in FIG. 3 to the position and orientation illustrated in FIG. 4.

FIG. 5 is also a top view of the measurement device 10 in which the U-shaped support 13X of the measurement device 10 in FIG. 1 is not illustrated. In the example illustrated in FIG. 5, the first motor 15 is installed inside a housing connected to the second support 14, and the second motor 16 is installed below the second support 14. In the example illustrated in FIG. 5, the first motor 15 transmits power to a columnar portion 20 on the second support 14 connected via a gear.

FIG. 6 is also a side view of the measurement device 10 in which a belt 21, the second support 14, the first motor 15, the second motor 16, and the pedestal 22 of the measurement device 10 in FIG. 1 are not illustrated. FIG. 7 is also a side view of the measurement device 10 in which the belt 21 of the measurement device 10 illustrated in FIG. 1 is locked to the upper end of the first support 13, and the second support 14, the first motor 15, the second motor 16, and the pedestal 22 are illustrated. In the example illustrated in FIG. 7, the first motor 15 transmits power generated by rotation to the upper end of the first support 13 via the columnar portion 20 and the belt 21, and rotates the U-shaped support 13X rotatably locked to the two columnar supports 13Y. Examples of the belt 21 include a timing belt.

The measurement section 17 measures the angle of the microphone 11. For example, the measurement section 17 measures the angle of the microphone 11 with respect to the vertical direction. Hereinafter, an example of the measurement section 17 will be described with reference to FIG. 2. As illustrated in the diagram of the measurement section in FIG. 2, examples of the measurement section 17 include an inertial measurement unit such as an Inertial Measurement Unit (IMU). In this case, the position and orientation of the microphone 11 are obtained by integrating the acceleration and the angular velocity of the microphone 11 in the three-dimensional directions measured by the measurement section 17. The installation position of the measurement section 17 is not particularly limited as long as the angle of the microphone 11 can be measured, and examples thereof include a position having the same angle as the angle of the microphone 11, such as a position between the end of the microphone 11 on the side opposite to the sound receiving point 11X and the first support 13.

The boom 18 fixes the microphone 11 to the first support 13. The installation position of the boom 18 is not particularly limited, but examples thereof include a position where the end of the microphone 11 on the side opposite to the sound receiving point 11X and the U-shaped support 13X can be connected to each other, that is, a position between the end of the microphone 11 on the side opposite to the sound receiving point 11X and the first support 13, as illustrated in FIG. 1.

The third motor 19 directly or indirectly drives the microphone 11 so that the distance from the rotation center 12 to the microphone 11 is variable. The installation position of the third motor 19 is not particularly limited as long as the third motor 19 is located at a position where the microphone 11 can be directly or indirectly driven so that the distance from the rotation center 12 to the microphone 11 is variable. The installation position of the third motor 19 includes, for example, a position between the boom 18 and the first support 13, such as a position where the boom 18 and the U-shaped support 13X are fixed, as illustrated in FIG. 1. In this case, the third motor 19 drives the boom 18 to indirectly drive the microphone 11.

In the example illustrated in FIG. 1, the measurement device 10 includes the boom 18. However, for example, when the length of the microphone 11 corresponds to the length including the boom 18, and the microphone 11 is directly supported by the U-shaped support 13X in the first support 13 on the side opposite to the sound receiving point 11X, the measurement device 10 need not include the boom 18. In this case, the third motor 19 directly drives the microphone 11 so that the distance from the rotation center 12 to the microphone 11 is variable. The installation position of the third motor 19 is not particularly limited, and may be, for example, an intersection point between the end of the microphone 11 on the side opposite to the sound receiving point 11X and the first support 13.

### 2. Modification

In the example illustrated in FIG. 1, the first support 13 directly or indirectly supports the microphone 11 at an end of the microphone 11 on the side opposite to the sound receiving point 11X so that the sound receiving point 11X is located in the air at a predetermined distance from the rotation center 12. However, the first support 13 may directly or indirectly support the microphone 11 such that the sound receiving point 11X is located at the rotation center 12. In this case, the first motor 15 rotates the first support 13 in the vertical direction so that the position of the sound receiving point 11X is constant.

The first support 13 may directly or indirectly support the microphone 11 at a position other than the side opposite to the sound receiving point 11X or the end as long as the first support 13 can directly or indirectly support the microphone 11 such that the sound receiving point 11X is located in the air at a predetermined distance from the rotation center 12 or at the rotation center 12. For example, when the sound receiving point 11X is provided near the base of the microphone 11 and the connecting portion is provided near the same side as the sound receiving point 11X as in some gun microphones, the first support 13 may directly or indirectly support the microphone 11 at the connecting portion.

### 3. Second Embodiment

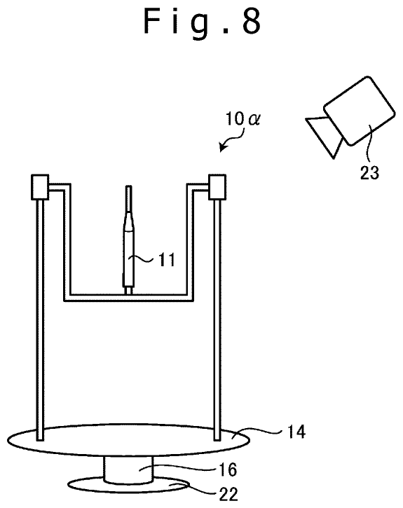

The measurement device according to one aspect of the present disclosure may further include a sensor that detects a position of at least one of the microphone or the measurement device. For example, the measurement device according to one aspect of the present disclosure may further include a sensor that detects the position of the microphone, instead of or in addition to the measurement section. Hereinafter, a measurement device 10x according to the second embodiment will be described with reference to FIG. 8. FIG. 8 is a schematic view illustrating an example of a measurement device according to the second embodiment. The shape of the measurement device 10α illustrated in FIG. 8 schematically represents the shape of the measurement device 10 according to the first embodiment illustrated in FIG. 1 and the like. The components denoted by the same reference numerals as those of the components of the measurement device 10 illustrated in FIG. 1 and the like have the same functions as those of the components of the measurement device 10.

In the example illustrated in FIG. 8, the measurement device 10α further includes a sensor 23 that detects the position of the microphone 11 in addition to the components of the measurement device 10 according to the first embodiment. Except for this point, the measurement device 10α is the same as the measurement device 10 according to the first embodiment. In the example illustrated in FIG. 8, the sensor 23 is an image pickup unit such as a camera that detects the position and orientation (angle) of the sound receiving point 11X of the microphone 11, and images the microphone 11 from above such as obliquely above the microphone 11, but may be mounted on the measurement device 10α. In this case, the installation position of the sensor 23 is not particularly limited as long as the position of the microphone 11 can be detected. In the example illustrated in FIG. 8, the sensor 23 detects only the position of the microphone 11 by imaging the microphone 11 from obliquely above the microphone 11, but may detect the position of the measurement device 10α based on imaging information where the measurement device 10 is imaged instead of or in addition to the microphone 11.

### 4. Third Embodiment

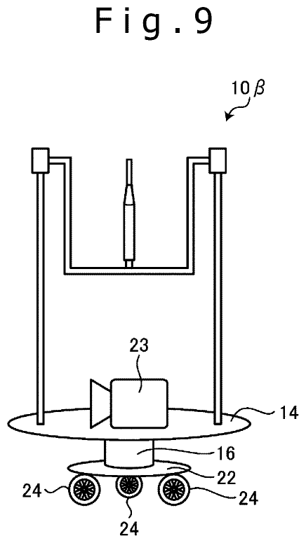

The measurement device according to one aspect of the present disclosure may further include a wheel for moving the measurement device, the wheel being provided below the second support. Hereinafter, a measurement device 10β according to the third embodiment will be described with reference to FIG. 9. FIG. 9 is a schematic view illustrating an example of the measurement device according to the third embodiment. The shape of the measurement device 10β illustrated in FIG. 9 schematically represents the shape of the measurement device 10 according to the first embodiment illustrated in FIG. 1 and the like. In FIG. 9, components denoted by the same reference numerals as those of the components of the measurement device 10 illustrated in FIG. 1 and the like have the same functions as those of the components of the measurement device 10.

In the example illustrated in FIG. 9, the measurement device 10β further includes wheels 24 that are installed below the second support 14 and move the measurement device 10β, and the sensor 23 that detects the position of the measurement device 10β, in addition to the components of the measurement device 10 according to the first embodiment. Except for this point, the measurement device 10β is the same as the measurement device 10 according to the first embodiment. In the example illustrated in FIG. 9, the wheels 24 are tires that are connected to the pedestal 22 below the second support 14 and can be controlled by a motor, but may be tires or the like that manually move the measurement device 10β. In the example illustrated in FIG. 9, the sensor 23 is installed on the second support 14 and detects the position of the measurement device 10β, but may be installed at a position independent of and away from the measurement device 10β and detect the position of the microphone 11 instead of or in addition to the position of the measurement device 10β. For example, when the sensor 23 is installed not on the second support 14 but obliquely above the microphone 11, the schematic shape of the measurement device 10βis a shape in which the wheels 24 are provided below the second support 14 of the measurement device 10α illustrated in FIG. 8. Examples of the sensor 23 installed on the second support 14 include a sensor having a self-position estimation function such as Simultaneous Localization and Mapping (SLAM). Examples of the sensor 23 installed at a position independent of the measurement device 10β include a sensor installed in a room or the like.

### 5. Fourth Embodiment

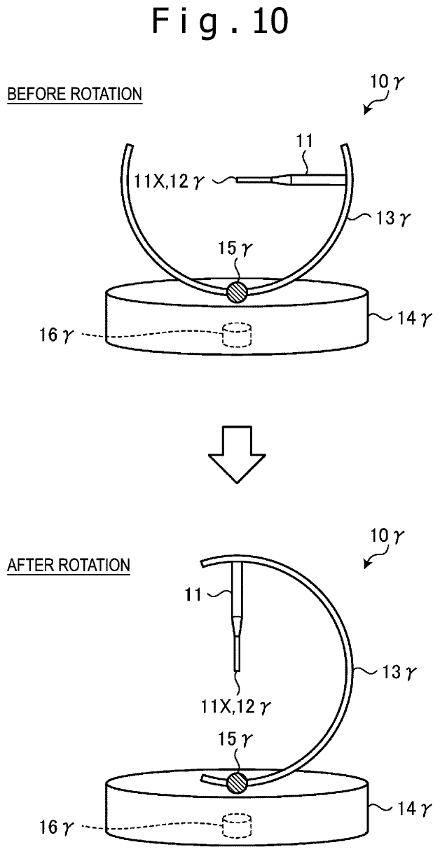

In the measurement device according to one aspect of the present disclosure, the first support may have a circular shape or an arc shape. Hereinafter, a measurement device 10γ according to the fourth embodiment will be described with reference to FIG. 10. FIG. 10 is a schematic view illustrating an example of the measurement device according to the fourth embodiment. In the measurement device 10γ illustrated in FIG. 10, the shapes of the components are schematically represented. In FIG. 10, components denoted by the same reference numerals as those of the components of the measurement device 10 illustrated in FIG. 1 and the like have the same functions as those of the components of the measurement device 10.

In the example illustrated in FIG. 10, the measurement device 10γ includes an arc-shaped first support 13γ and a turntable-shaped second support 14γ instead of the first support 13 and the second support 14 of the measurement device 10 according to the first embodiment. Except for this point, the measurement device 10γ is the same as the measurement device 10 according to the first embodiment.

In the example illustrated in the diagram before rotation in FIG. 10, the arc-shaped first support 1365 directly supports the microphone 11 so that the sound receiving point 11X is located at a rotation center 12γ. The second support 14γ supports the first support 13γ at the lower end of the first support 13γ. In the example illustrated in the diagram after rotation in FIG. 10, the first motor 15γ rotates the first support 13γ in the vertical direction by rotating the first support 13γ counterclockwise so that the position of the sound receiving point 11X is constant. A second motor 16γ rotates the second support 14γ in the horizontal direction. As a result, the orientation of the sound receiving point 11X of the microphone 11 is changed from the orientation illustrated in the diagram before rotation in FIG. 10 to the orientation illustrated in the diagram after rotation in FIG. 10.

In the example illustrated in FIG. 10, the arc-shaped first support 13γ directly supports the microphone 11 such that the sound receiving point 11X is located at the rotation center 12γ. However, the first support 13γ may directly or indirectly support the microphone 11 so that the sound receiving point 11X is located in the air at a predetermined distance from the rotation center 12γ. For example, the first support 13γ may support the microphone 11 via the boom 18 or the like illustrated in FIG. 1 such that the sound receiving point 11X is located in the air at a predetermined distance from the rotation center 12γ. In this case, the position of the sound receiving point 11X is changed in addition to the orientation of the sound receiving point 11X by the rotation of the first motor 15γ and the second motor 16γ.

### 6. Fifth Embodiment

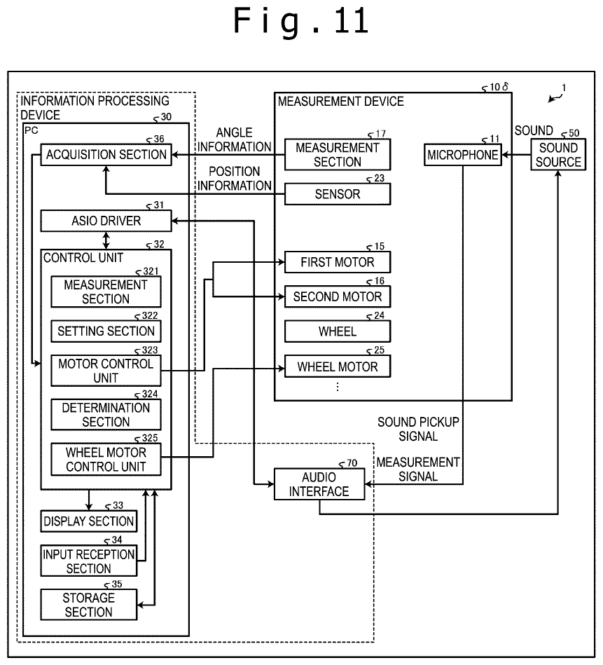

A measurement system according to one aspect of the present disclosure is a measurement system for performing acoustic measurement, and includes a measurement device and an information processing device. Hereinafter, a measurement system 1 according to the fifth embodiment will be described with reference to FIG. 11. FIG. 11 is a block diagram illustrating an example of the measurement system according to the fifth embodiment.

In the example illustrated in FIG. 11, the measurement system 1 is a measurement system for performing acoustic measurement, and includes a measurement device 10δ, a PC (information processing device) 30, a sound source 50, and an audio interface (information processing device) 70.

In the example illustrated in FIG. 11, the measurement device 10δ further includes the sensor 23, the wheel 24, and a wheel motor 25 in addition to the components of the measurement device 10 according to the first embodiment. In the example illustrated in FIG. 11, the sensor 23 detects the positions of the microphone 11 and the measurement device 10δ. The wheel motor 25 moves the wheel 24. Specifically, the wheel motor 25 rotates the wheel 24.

In the example illustrated in FIG. 11, the PC 30 includes an Audio Stream Input Output (ASIO) driver 31, a control unit 32, a display section 33, an input reception section 34, a storage section 35, and an acquisition section 36.

The acquisition section 36 acquires various types of information. In the example illustrated in FIG. 11, the acquisition section 36 acquires, via a Universal Serial Bus (USB) cable, angle information regarding the angle of the microphone 11 measured by the measurement section 17 and position information regarding the positions of the microphone 11 and the measurement device 10δ detected by the sensor 23. In the above-described example, the acquisition section 36 acquires the angle information and the position information via the USB cable, but an acquisition method of the angle information and the position information is not particularly limited, and for example, an acquisition method via a Local Area Network (LAN), the Internet, or the like may be used instead of the USB cable.

The ASIO driver 31 transmits and receives signals to and from the audio interface 70. For example, the ASIO driver 31 transmits and receives various signals such as a sound pickup signal and a measurement signal to and from the audio interface 70.

The control unit 32 controls the entire PC 30. The control unit 32 is configured by, for example, one or more processors having a program in which processing procedures are defined and an internal memory in which control data is stored, and the processor executes processes using the program and the internal memory. Examples of the control unit 32 include an electronic circuit such as a CPU, an MPU, and a GPU, and an integrated circuit such as an ASIC and an FPGA. In the example illustrated in FIG. 11, the control unit 32 includes a measurement tool 321, a setting section 322, a motor control unit 323, a determination section 324, and a wheel motor control unit 325.

The measurement tool 321 is a tool for measuring the reverberation characteristics at the position of the measurement device 10δ in the measurement environment, such as the measurement position or the position of the measurement device 10δ in a predetermined room. The measurement position refers to a position of the microphone 11 when the acoustic measurement is performed, and refers to, for example, a position of the microphone 11 when the acoustic measurement is performed in the measurement environment. The measurement position, which is the position of the microphone 11, may include the angle (orientation) of the microphone 11. The measurement position is moved by the rotation of the first support 13 by the first motor 15 and the rotation of the second support 14 by the second motor 16. The measurement position may be moved together with the movement of the measurement device 10δ by the wheel 24.

The setting section 322 sets a measurement position that is the position of the microphone 11 when the acoustic measurement is performed. For example, the setting section 322 sets the measurement position that is the position of the microphone 11 when acoustic measurement is performed according to input information of which an input is received by the input reception section 34. As an example, the setting section 322 sets the angle of the microphone 11 and the position of the measurement device 10δ in a predetermined room. As another example, the setting section 322 sets only the angle of the microphone 11. In the example illustrated in FIG. 11, the setting section 322 performs various settings such as setting of the position of the measurement device 10δ in the measurement environment such as a predetermined point in a predetermined room, initializing of the PC 30 and the measurement device 10δ, setting of the origin in the measurement range, setting of the ASIO driver 31, setting of the type of measurement signal, and setting of the angle of the first support 13 and the angle of the second support 14, in addition to the measurement position. The setting section 322 calculates the rotation angle of the first support 13 and the rotation angle of the second support 14 for rotating the first support 13 and the second support 14 so as to obtain the angle of the first support 13 and the angle of the second support 14 corresponding to the set measurement position. The setting section 322 calculates the number of rotations of the wheel 24 by the wheel motor 25 for moving the measurement device 10δ so that the microphone 11 is located at the measurement position, based on the setting information regarding the measurement position and the position information detected by the sensor 23.

The motor control unit 323 controls the rotation angle of the first support 13 by the first motor 15 and the rotation angle of the second support 14 by the second motor 16 based on the angle of the microphone 11 measured by the measurement section 17. For example, the setting section 322 calculates the rotation angle of the first support 13 by the first motor 15 and the rotation angle of the second support 14 by the second motor 16 based on the angle of the microphone 11 measured by the measurement section 17, which is the angle indicated by the angle information acquired by the acquisition section 36. The motor control unit 323 causes the first motor 15 to rotate the first support 13 by the rotation angle of the first support 13 calculated by the setting section 322, and causes the second motor 16 to rotate the second support 14 by the rotation angle of the second support 14 calculated by the setting section 322. In this case, the motor control unit 323 outputs, to the first motor 15 and the second motor 16, control signals for controlling the rotation of the first support 13 by the first motor 15 and the rotation of the second support 14 by the second motor 16, for example, via a USB cable. Accordingly, the motor control unit 323 controls the position and angle of the microphone 11, which is the measurement position, based on the angle of the microphone 11 measured by the measurement section 17 as a result. In the above-described example, the motor control unit 323 outputs the control signal to the first motor 15 and the second motor 16 via the USB cable, but the control signal can be output by any means, and for example, the control signal may be output via a LAN, the Internet, or the like instead of the USB cable.

The determination section 324 determines whether or not acoustic measurement has been performed at at least one of the measurement position set by the setting section 322 or the position of the measurement device 10δ. For example, the determination section 324 determines whether or not the acoustic measurement has been completed at all the measurement positions indicated by the setting information set by the setting section 322.

The wheel motor control unit 325 controls the number of rotations of the wheel 24 by the wheel motor 25 based on the position information detected by the sensor 23. For example, the setting section 322 calculates the number of rotations of the wheel 24 by the wheel motor 25 for moving the measurement device 10δ so that the microphone 11 is located at the measurement position, based on the position information detected by the sensor 23 and acquired by the acquisition section 36 and the setting information regarding the measurement position. The wheel motor control unit 325 causes the wheel motor 25 to rotate the wheel 24 by the number of rotations calculated by the setting section 322. In this case, the wheel motor control unit 325 outputs a control signal to the wheel motor 25 via, for example, a USB cable, for controlling the rotation of the wheel 24 by the wheel motor 25. Accordingly, the wheel motor control unit 325 controls the position of the measurement device 10δ in the measurement environment such as a predetermined point in a predetermined room based on the position information detected by the sensor 23, and controls the position of the microphone 11 and the like together with the position of the measurement device 10δ, as a result. In the above-described example, the wheel motor control unit 325 outputs the control signal to the wheel motor 25 via the USB cable, but the control signal can be output by any means, and for example, the control signal may be output via a LAN, the Internet, or the like instead of the USB cable.

The display section 33 displays various types of information such as measurement information. The measurement information refers to information on the measurement result and the measurement condition of the acoustic measurement. Examples of the measurement result include raw data such as sound acquired by the microphone 11 and a sound pickup signal obtained by converting the acquired sound by the audio interface 70. Examples of the measurement conditions include information on various measurement conditions at the time of measurement such as measurement date and time, temperature, humidity, measurer's name, shape information of measurement environment, measurement position, information on the measurement system 1, and measurement signal. The measurer name may be, for example, an operator name. Examples of the shape information of the measurement environment include the 3D shape information of the measurement environment. Examples of the information on the measurement system 1 include information on the sound source 50, the microphone 11 in the measurement device 108, the version of the measurement tool 321 in the PC 30, and the equipment of the audio interface 70. Examples of the display section 33 include a display of a Personal Computer (PC), and a touch panel. When the display section 33 is a touch panel, the display section 33 also functions as the input reception section 34.

The input reception section 34 receives input of various types of information. For example, the input reception section 34 receives an input of input information on the measurement condition such as a measurement position from a user.

The storage section 35 stores various types of information such as measurement information. Examples of the storage section 35 include a storage device such as a Hard Disk Drive (HDD), a Solid State Drive (SSD), and an optical disk, and a semiconductor memory capable of rewriting data such as a Random Access Memory (RAM), a flash memory, and a Non-Volatile Static Random Access Memory (NVSRAM). The storage section 35 stores an Operating System (OS) and various programs executed by the PC 30.

The sound source 50 outputs sound to the microphone 11. For example, when the sound source 50 receives a measurement signal from the audio interface 70, the sound source 50 outputs sound to the microphone 11 based on the measurement signal. Examples of the sound source 50 include a speaker.

The audio interface 70 functions as an output control unit that causes the sound source 50 to output sound. The sound acquired by the microphone is converted into a sound pickup signal, and the sound output from the sound source 50 is converted into a measurement signal. The audio interface 70 transmits and receives the sound pickup signal and the measurement signal to and from the ASIO driver 31.

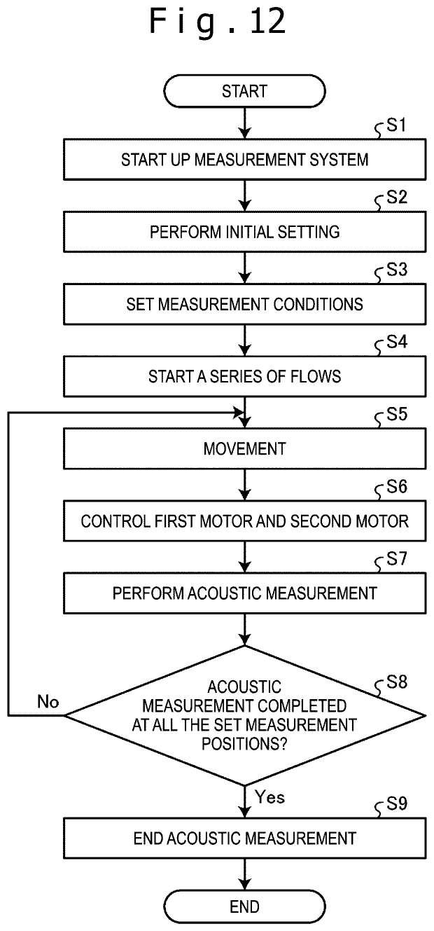

Next, an example of a measurement processing performed by the measurement system 1 according to the fifth embodiment will be described with reference to FIG. 12. FIG. 12 is a flowchart illustrating an example of the measurement processing performed by the measurement system according to the fifth embodiment.

In step S1, the control unit 32 of the PC 30 starts up the measurement system 1. For example, the control unit 32 starts up each unit of the PC 30 including the setting section 322.

In step S2, the setting section 322 of the PC 30 performs initial setting. For example, the setting section 322 initializes the PC 30 and the measurement device 10δ, sets the origin in the measurement range, and sets the ASIO driver 31.

In step S3, the setting section 322 sets the measurement conditions. For example, the setting section 322 sets a measurement position, which is the position of the microphone 11 when the acoustic measurement is performed, and the type of measurement signal.

In step S4, the measurement device 10δ starts a series of flows to perform the acoustic measurement at one or more measurement positions.

In step S5, the measurement device 10δ moves so that the microphone 11 is located at the measurement position. For example, the wheel motor control unit 325 outputs, to the wheel motor 25, a control signal for rotating the wheel 24 by the number of rotations for moving the measurement device 10δ such that the microphone 11 is located at the measurement position. The wheel motor 25 rotates the wheel 24 based on the control signal, thereby moving the measurement device 10δ so that the microphone 11 is located at the measurement position.

In step S6, the motor control unit 323 of the PC 30 controls the first motor 15 and the second motor 16, thereby changing the orientation of the microphone 11. For example, the motor control unit 323 controls the first motor 15 and the second motor 16 so that the angle and the orientation of the microphone 11 at the measurement position are in the state indicated by the setting information, based on the measurement angle indicated by the setting information set by the setting section 322 and the angle information indicated by the angle measured by the measurement section 17. Specifically, the motor control unit 323 controls the rotation angle of the first support 13 by the first motor 15 and the rotation angle of the second support 14 by the second motor 16 so as to achieve the above-described state.

In step S7, the measurement device 10δ performs an acoustic measurement. For example, the control unit 32 in the PC 30 causes the audio interface 70 to output sound from the sound source 50 via the ASIO driver 31. The microphone 11 of the measurement device 10δ acquires (records) the sound output (reproduced) from the sound source 50 at the measurement position, which is the position of the microphone 11 moved together with the measurement device 10δ by the wheel 24, and the orientation of the microphone 11 changed by the control of the first motor 15 and the second motor 16 by the motor control unit 323. The audio interface 70 converts the sound recorded by the microphone 11 into a sound pickup signal, converts the sound reproduced from the sound source 50 into a measurement signal, and transmits the signals to the ASIO driver 31.

In step S8, the determination section 324 of the PC 30 determines whether or not acoustic measurements at all the measurement positions indicated by the setting information have been completed. When the determination section 324 determines that the acoustic measurements at all the measurement positions indicated by the setting information have been completed (Yes in step S8), the acoustic measurements are ended. When the determination section 324 determines that the acoustic measurements at all the measurement positions indicated by the setting information have not been completed (No in step S8), the process returns to step S5. Before returning to the processing of step S5, the setting section 322 may reset the measurement conditions for measuring the measurement positions other than the measurement positions already measured.

### 7. Modification

The components of the respective sections illustrated in the drawings are functionally conceptual, and are not necessarily physically configured as illustrated in FIG. 11. That is, specific forms of distribution and integration of the devices are not limited to those in FIG. 11, and all or a part thereof can be functionally or physically distributed or integrated in any unit according to various loads, usage conditions, and the like. The same applies to the following embodiments.

As an example, the control unit 32 in the PC 30 may be configured by a plurality of devices including a control unit having the measurement tool 321, the setting section 322, and the determination section 324, and a control device (for example, a control box which is a box-shaped control device) having the motor control unit 323 outside the PC 30. In this case, the motor control unit 323 is connected to the PC 30 by a USB cable. The motor control unit 323 controls the rotation of the first support 13 by the first motor 15 and the rotation of the second support 14 by the second motor 16 based on the rotation angle of the first support 13 and the rotation angle of the second support 14 calculated by the setting section 322 of the PC 30 via the USB cable. In the above-described example, the motor control unit 323 is connected to the PC 30, the first motor 15, and the second motor 16 by the USB cable. However, the method of connecting the motor control unit 323 to the PC 30, the first motor 15, and the second motor 16 is not particularly limited, and may be a method of connecting via a LAN, the Internet, or the like, for example.

As another example, at least a part of the control unit 32 such as the acquisition section 36 and the motor control unit 323 may be provided in the measurement device 10δ instead of the PC 30. In this case, the acquisition section 36 of the measurement device 10δ acquires the angle information measured by the measurement section 17 of the measurement device 10δ and the position information detected by the sensor 23, and the motor control unit 323 of the measurement device 100 controls the first motor 15 and the second motor 16 based on the angle information and the position information acquired by the acquisition section 36.

### 8. Sixth Embodiment

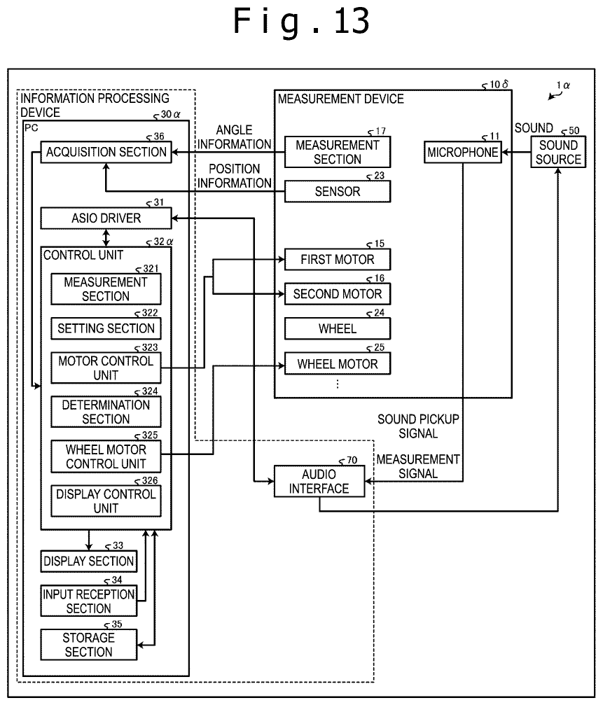

The information processing device of the measurement system according to one aspect of the present disclosure may display the measurement position where the acoustic measurement has not been performed and the measurement position where the acoustic measurement has been performed in different display modes. Hereinafter, a measurement system 1α according to the sixth embodiment will be described with reference to FIG. 13. FIG. 13 is a block diagram illustrating an example of the measurement system according to the sixth embodiment.

In the example illustrated in FIG. 13, the measurement system la includes a PC 30α instead of the PC 30. Except for this point, the measurement system la is the same as the measurement system 1 according to the fifth embodiment. The PC 30α includes a control unit 32α instead of the control unit 32 in the fifth embodiment. Except for this point, the PC 30α is the same as the PC 30 in the fifth embodiment. The control unit 32α further includes a display control unit 326. Except for this point, the control unit 32α is the same as the control unit 32 in the fifth embodiment.

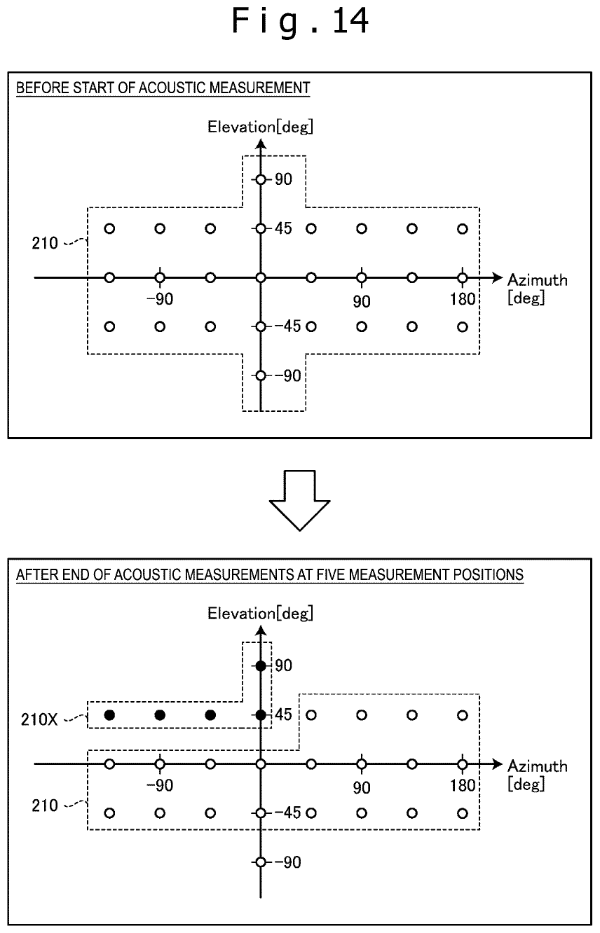

The display control unit 326 causes the display section 33 to display the measurement position where the acoustic measurement has not been performed and the measurement position where the acoustic measurement has been performed among the measurement positions set by the setting section 322 in different display modes. Hereinafter, an example of display control by the display control unit 326 will be described with reference to FIG. 14. FIG. 14 is a diagram for explaining an example of display control.

In the example illustrated in FIG. 14, a case where the user inputs input information on a measurement condition such as a measurement position to a touch panel in which the input reception section 34 and the display section 33 are integrated using the measurement application will be described. Hereinafter, a case where a circular measurement position as a User Interface (UI) element is touched by the user and the input of the user is received by the input reception section 34 will be described. In this case, the setting section 322 sets the touch position of the user received by the input reception section 34 as the measurement position. As illustrated in the diagram before the start of the acoustic measurement in FIG. 14, the display control unit 326 causes the display section 33 to display the measurement positions where the acoustic measurements set by the setting section 322 have not been performed as red circular measurement positions 210. In the example illustrated in the diagram before the start of the acoustic measurement in FIG. 14, Azimuth [deg] corresponds to the horizontal direction described above, and Elevation [deg] corresponds to the vertical direction described above.

The display control unit 326 causes the display section 33 to display the measurement positions where the acoustic measurement has not been performed among the measurement positions set by the setting section 322 in a display mode different from that of the measurement positions where the acoustic measurement has been performed. For example, when the acoustic measurements have been performed at five measurement positions, the display control unit 326 causes the display section 33 to display five measurement positions 210X in a color different from that of the measurement positions 210 where the acoustic measurements have not been performed, as illustrated in the diagram after the acoustic measurements at the five measurement positions are finished in FIG. 14. As an example, the display control unit 326 changes the measurement positions 210X where the acoustic measurements are performed from red circles to green circles, and causes the display section 33 to display the measurement positions.

### 9. Seventh Embodiment

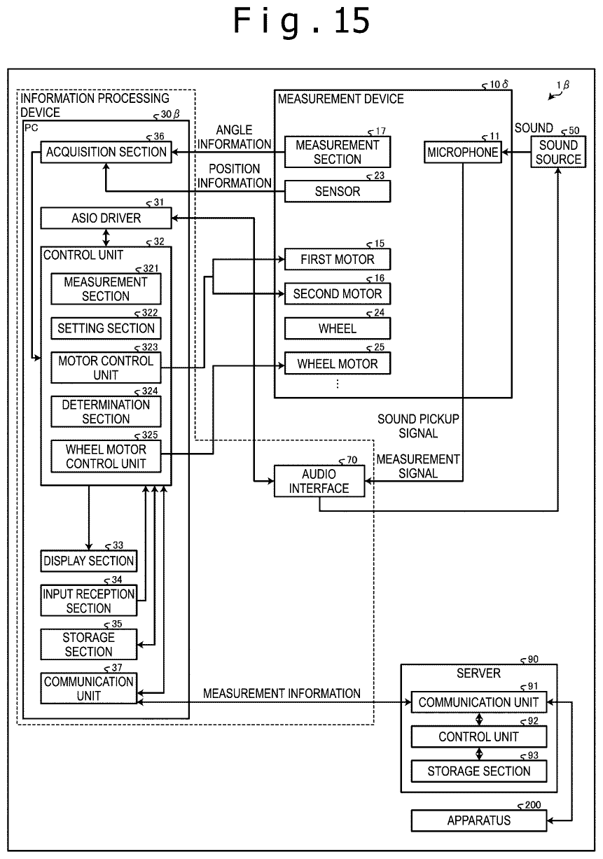

The information processing device of the measurement system according to one aspect of the present disclosure may transmit measurement information on the measurement result of the acoustic measurement and various measurement conditions obtained by the acoustic measurement according to the embodiments to a specific server. In this way, the information processing device may pass the measurement information to a third party as a database for various uses, such as passing the measurement information to a third party as a database to contribute to business development. Hereinafter, a measurement system 16 according to the seventh embodiment will be described with reference to FIG. 15. FIG. 15 is a block diagram illustrating an example of the measurement system according to the seventh embodiment.

In the example illustrated in FIG. 15, the measurement system 1β further includes a PC 30β instead of the PC 30. Except for this point, the measurement system 1β is the same as the measurement system 1 according to the fifth embodiment.

The PC 30β further includes a communication unit (transmission section) 37. The communication unit 37 is connected to an external network, or receives data from another apparatus or transmits data to another apparatus via a USB cable or the like. In the example illustrated in FIG. 15, the communication unit 37 transmits the measurement information on the measurement result and the measurement condition of the acoustic measurement to a server 90 that can be accessed only by a subject authorized to use the measurement information. For example, the communication unit 37 uploads the measurement information to the server 90 and manages the measurement information. The communication unit 37 may further transmit the angle information and the position information acquired from the measurement device 100 by the acquisition section 36 to the server 90. Accordingly, the communication unit 37 enables the user of an apparatus 200 to access the server 90, download data such as measurement information such as a measurement result of the acoustic measurement from the server 90, and use the data. The target to which the use authority of the measurement information is given is not particularly limited as long as usage of the measurement information can be authorized, but examples thereof include the apparatus 200 for which usage of the measurement information is authorized, a user authorized to use the measurement information, and the like. Examples of the communication unit 37 include a Network Interface Controller (NIC) that performs communication via a LAN, the Internet, or the like.

The server 90 is not particularly limited as long as the server is accessible only by a subject authorized to use the measurement information, and a cloud server or the like is exemplified. The measurement information related to various measurement conditions includes, but is not limited to, measurement date and time, temperature, moisture, operator name, 3D shape information of measurement environments, measurement positions in the measurement environments, substrate information (speaker, microphone, audio interface), versions of measurement tools, measurement signals, measurement positions, and the like.

In the example illustrated in FIG. 15, the server 90 includes a communication unit 91, a control unit 92, and a storage section 93. The server 90 acquires the results of the acoustic measurements and the measurement information on the measurement conditions from the PC 30β via the communication unit 91 and the communication unit 37, and stores the measurement information in the storage section 93. When the apparatus 200 accesses the server 90 and inputs a desired condition, the server 90 may store the measurement information in the storage section 93 so that the measurement information such as the measurement result of the acoustic measurement matching the condition can be downloaded.

The communication unit 91 receives the measurement information from the PC 30β and transmits the measurement information to the apparatus 200. Examples of the communication unit 91 include an NIC that performs communication via a LAN, the Internet, or the like.

The control unit 92 controls the entire server 90. The control unit 92 is configured by, for example, one or more processors having an internal memory in which a program in which each processing procedure is defined and control data is stored, and the processor executes each processing using the program and the internal memory. Examples of the control unit 92 include an electronic circuit such as a CPU, an MPU, and a GPU, and an integrated circuit such as an ASIC and an FPGA.

The storage section 93 stores various types of information such as measurement information. For example, the storage section 93 registers the measurement information in a database. Examples of the storage section 93 include a storage device such as an HDD, an SSD, and an optical disk, and a semiconductor memory capable of rewriting data such as a RAM, a flash memory, and an NVSRAM. The storage section 93 stores an OS and various programs executed by the server 90.

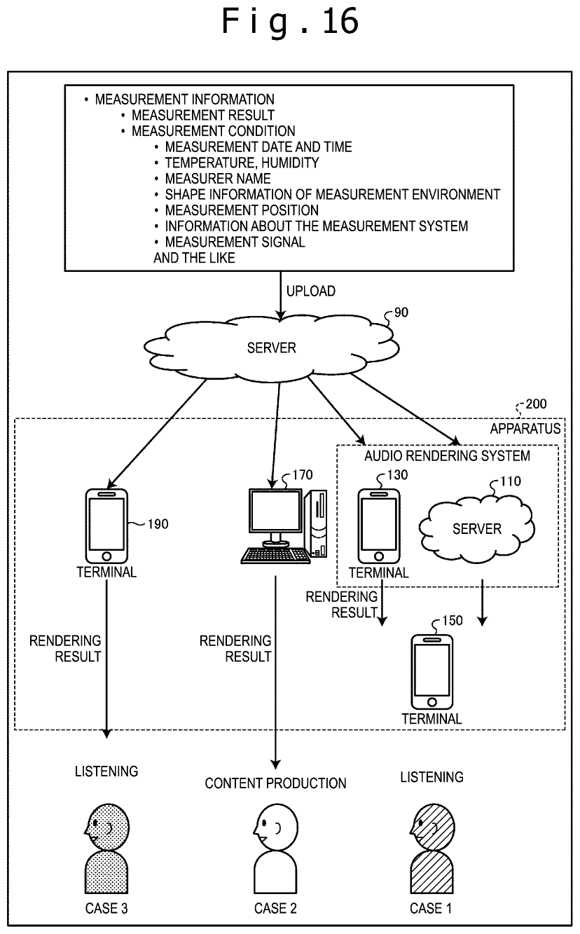

Hereinafter, an example of transmission of the measurement information by the communication unit 37 in the PC 30β will be described with reference to FIG. 16. FIG. 16 is a diagram for explaining an example of transmission of measurement information.

In the example illustrated in FIG. 16, the communication unit 37 in the PC 30β uploads the measurement information to the server 90 so that the measurement information can be used by the apparatus 200 (the users of terminals 150, 170, and 190 and the audio rendering system). Examples of the terminals 150, 170, and 190 include terminals of users authorized to use the measurement information by the users of the PC 30β and the measurement device 105 who are the persons who perform the acoustic measurements. Examples of the audio rendering system include a server 110 and a terminal 130 of a content distributor of games, metaverse, music, videos, and the like, to which the user of the PC 30β and the measurement device 10β has been authorized to use the measurement information. The server 110 is not particularly limited, and may be, for example, a cloud server as illustrated in FIG. 16. In the example illustrated in FIG. 16, all of the terminal 130, the terminal 150, and the terminal 190 are Smartphones, but these terminals are not limited to smartphones, and may be, for example, PCs or the like. As illustrated in FIG. 16, the terminal 170 for content creators is usually a PC or the like, but is not particularly limited as long as it is capable of content production, and may be a smartphone or the like, for example.

In case 1, the communication unit 37 in the PC 30β uploads the measurement information to the server 90 for the content distributor. In this case, the server 110 of the content distributor or the terminal 130, which is a client device owned by the user, acquires the measurement result of the RIR or the like and performs the rendering processing. That is, the end user may perform the rendering processing on the measurement information acquired by the terminal 130 and directly listen to the result via a headphone or the like, or may acquire, from the terminal 150, the result of the rendering processing performed by the server 110 using the measurement information acquired from the server 90 and listen to the rendering result via a headphone or the like.

In case 1, as an example, a case is assumed in which a measurement signal such as an object signal of content is distributed from the server 110, and the terminal 130, which is a client device, performs rendering processing. In this case, the terminal 130 such as a smartphone performs rendering processing using an RIR designated (determined) for each content by a content creator who is a creator of the content. The terminal 130 performs rendering processing so that the recorded sound source is distributed as an object including three-dimensional position information and is restored and reproduced in a space at the time of reproduction. As another example, a case is also assumed in which the server 110 performs the rendering processing instead of the terminal 130 which is a client device possessed by the user. In this case, the server 110 performs rendering processing using the RIR, and distributes the rendering result to the end user or the like.

In case 2, the communication unit 37 in the PC 30β uploads the measurement information to the server 90 for the content creator. In this case, the terminal 170 of the content creator renders the content based on the measurement information acquired from the server 90. For example, the content creator creates content as a rendering result using the RIR included in the measurement information by using a Digital Audio Workstation (DAW) on the terminal 170 which is a PC. In this case, the content creator creates the content by applying the RIR included in the measurement information to the reverb used for sound field representation in the creation process.

In case 3, the communication unit 37 of the PC 30β uploads measurement information to the server 90 for end users. In this case, the terminal 190 of the end user acquires the measurement information including the RIR from the server 90. The end user determines (designates) the RIR to be used for selection of the sound field mode among the RIRs included in the measurement information acquired by the terminal 190. The end user selects a sound field mode of a device capable of switching a sound field mode such as an AV amplifier or an in-vehicle audio device using the designated RIR. The end user applies the selected sound field mode to the music piece and listens to the same. The music pieces listened to by the user are not particularly limited, and may be, for example, music pieces on a CD owned by the end user, or music pieces Streamed by a distribution service. The device that the user listens to is not particularly limited, and may be, for example, an amplifier, a speaker, or the like, or may be a smartphone, a headphone, or the like. Case 3 also includes a case where the rendering processing is performed by using the RIR designated by the end user instead of the RIR designated (determined) by the content creator who is the creator of the content in case 1.

### 10. Eighth Embodiment

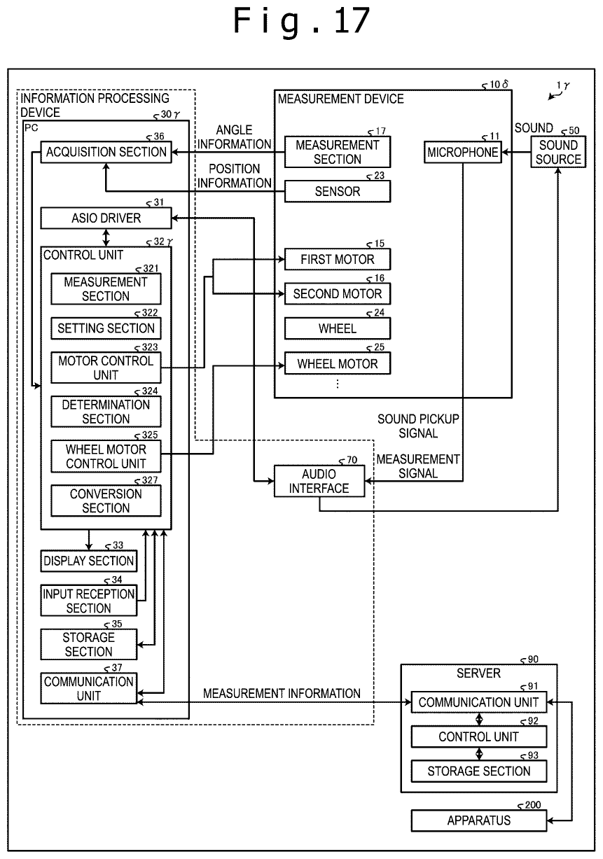

The information processing device of the measurement system according to one aspect of the present disclosure may convert a format of the measurement information based on the measurement position, and transmit the measurement information whose format has been converted to the server. Hereinafter, a measurement system 1γ according to the eighth embodiment will be described with reference to FIG. 17. FIG. 17 is a block diagram illustrating an example of the measurement system according to the eighth embodiment.

In the example illustrated in FIG. 17, the measurement system 1γ has a PC 30γ instead of the PC 30β. Except for this point, the measurement system 1γ is the same as the measurement system 1β according to the seventh embodiment.

The PC 30γ includes a control unit 32γ instead of the control unit 323 in the seventh embodiment. Except for this point, the PC 30γ is the same as the PC 306 in the seventh embodiment.

The control unit 32γ further includes a conversion section 327. Except for this point, the control unit 32γ is the same as the control unit 323 in the seventh embodiment. The conversion section 327 converts the format of the measurement information based on the measurement position. For example, the conversion section 327 converts the format of the measurement information into a format such as Ambisonics or Higher Order Ambisonics (HOA) based on the measurement position.

For example, the conversion section 327 converts the format of the measurement information into the Ambisonics format so that the order of Ambisonics increases as the number of measurement positions increases. In this case, the conversion section 327 performs estimation of the coefficient of Ambisonics and the like in addition to the determination of the order of Ambisonics, and executes an encoding processing of converting the format of the measurement information into a format such as Ambisonics.

The communication unit 37 transmits the measurement information whose format has been converted by the conversion section 327 to the server 90. For example, the communication unit 37 uploads the measurement information whose format has been converted to the server 90.

In the example described above, the control unit 32γ of the PC 30γ includes the conversion section 327, but the control unit 92 of the server 90 may include the conversion section 327. In this case, the conversion section 327 converts the format of the measurement information transmitted to the server 90 based on the measurement position.

### 11. Ninth Embodiment

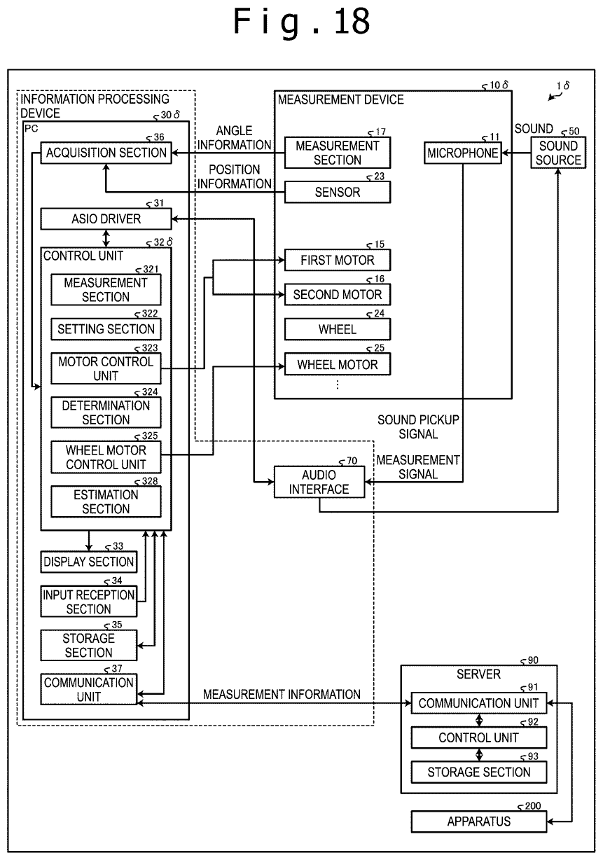

The information processing device of the measurement system according to one aspect of the present disclosure may estimate a measurement result of the acoustic measurement at a position where the acoustic measurement has not been performed, based on a measurement result of the acoustic measurement at one or more measurement positions. The information processing device may estimate a measurement result of the acoustic measurement when the sound source is installed at a position where the acoustic measurement has not been performed, based on the measurement result of the acoustic measurement by one or more sound sources. Hereinafter, a measurement system 1δ according to the ninth embodiment will be described with reference to FIG. 18. FIG. 18 is a block diagram illustrating an example of the measurement system according to the ninth embodiment.

In the example illustrated in FIG. 18, the measurement system 1δ includes a PC 30δ instead of the PC 30δ. Except for this point, the measurement system 18 is the same as the measurement system 1β according to the seventh embodiment.

The PC 30δ includes a control unit 32δ instead of the control unit 32 in the seventh embodiment. Except for this point, the PC 30δ is the same as the PC 30β in the seventh embodiment.

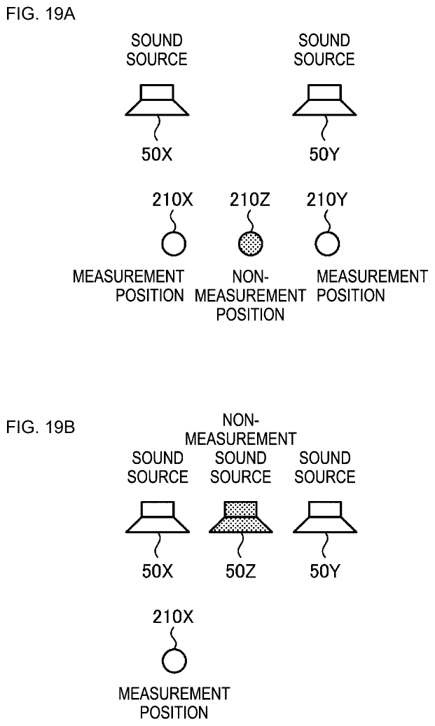

The control unit 32δ further includes an estimation section 328. Except for this point, the control unit 32δ is the same as the control unit 32 in the seventh embodiment. The estimation section 328 performs at least one of a first estimation of estimating a measurement result of acoustic measurement at a position where the acoustic measurement has not been performed based on the measurement results of acoustic measurement at one or more measurement positions or a second estimation of estimating a measurement result of acoustic measurement when the sound source 50 is installed at a position where acoustic measurement has not been performed based on the measurement results of acoustic measurement by one or more sound sources 50. Hereinafter, an example of estimation of a measurement result by the estimation section 328 will be described with reference to FIG. 19. FIG. 19 is a diagram for explaining an example of estimation of a measurement result.

In the example illustrated in FIG. 19 (A), the estimation section 328 performs the first estimation of estimating a measurement result of the acoustic measurement at a non-measurement position 210Z, which is the position where the acoustic measurement has not been performed indicated by the position information acquired by the acquisition section 36, based on the measurement results of the acoustic measurements at a plurality of the measurement positions 210X and 210Y indicated by the measurement information. For example, when the non-measurement position 210Z is located at the center between the measurement position 210X and the measurement position 210Y, the estimation section 328 estimates that a mean value obtained by weighted-averaging the measurement result at the measurement position 210X and the measurement result at the measurement position 210Y is the measurement result at the non-measurement position 210Z. When the measurement information further includes the measurement condition and the position information further includes the measurement position 210X, the measurement position 210Y, the position of a sound source 50X, and the position of a sound source 50Y, the estimation section 328 may estimate the measurement result of the acoustic measurement at the non-measurement position 210Z further based on at least one of the measurement condition or these positions. Note that the measurement position 210X illustrated in FIG. 19 (A) is merely an example of the measurement position where the acoustic measurement has been performed, and need not be the same position as the measurement position 210X illustrated in FIG. 14, which is an example of the measurement position where the acoustic measurement has been performed, and is not particularly limited as long as it is the measurement position where the acoustic measurement has been performed.

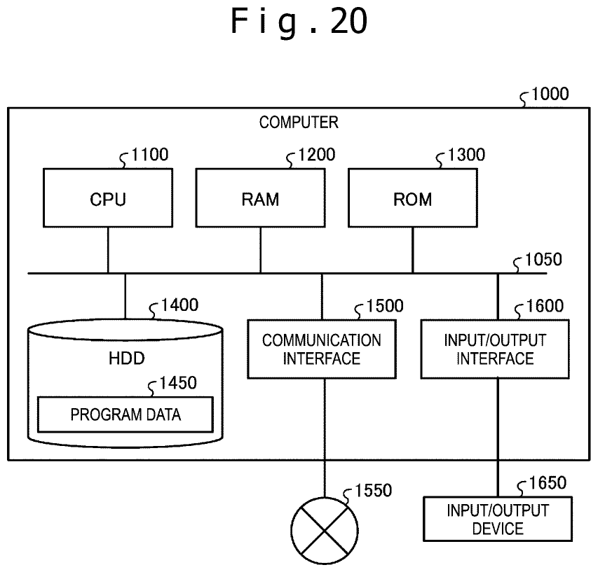

In the example illustrated in FIG. 20 (B), the estimation section 328 performs the second estimation of estimating a measurement result of the acoustic measurement when a non-measurement sound source 50Z which is the sound source where the acoustic measurement has not been performed is installed at the position where the acoustic measurement has not been performed indicated by the position information acquired by the acquisition section 36, based on the measurement results of the acoustic measurements by a plurality of the sound sources 50X and the sound source 50Y indicated by the measurement information. For example, the estimation section 328 estimates a measurement result of the acoustic measurement when the non-measurement sound source 50Z is installed at a position where the acoustic measurement has not been performed and sound is output from the non-measurement sound source 50Z, based on the measurement results of acoustic measurements when sound is output from a plurality of the sound sources 50X and the sound source 50Y. When the position of the non-measurement sound source 50Z is located at the center between the sound source 50X and the sound source 50Y, the estimation section 328 estimates that a mean value obtained by weighted-averaging the measurement result by the sound source 50X and the measurement result by the sound source 50Y is the measurement result by the non-measurement sound source 50Z. When the measurement information further includes the measurement condition and the position information further includes the measurement position 210X, the position of the sound source 50X, and the position of the sound source 50Y, the estimation section 328 may estimate the measurement result of the acoustic measurement by the non-measurement sound source 50Z further based on at least one of the measurement condition or these positions.

In the example described above, the control unit 32δ of the PC 30δ includes the estimation section 328, but the control unit 92 of the server 90 may include the estimation section 328.

### 12. Example of Hardware Configuration

The various devices such as the PC 30 and the server 90 described above may be configured to include a computer. An example will be described with reference to FIG. 20.

FIG. 20 is a block diagram illustrating an example of a hardware configuration of a device. An exemplary computer 1000 includes a CPU 1100, a RAM 1200, a Read Only Memory (ROM) 1300, an HDD 1400, a communication interface 1500, and an input/output interface 1600. The respective units of the computer 1000 are connected to each other via a bus 1050.

The CPU 1100 operates based on a program stored in the ROM 1300 or the HDD 1400, and controls each unit. For example, the CPU 1100 deploys programs stored in the ROM 1300 or the HDD 1400 to the RAM 1200 and executes processing corresponding to the various programs.

The ROM 1300 stores a boot program such as a Basic Input Output System (BIOS) executed by the CPU 1100 at the start of the computer 1000, a program depending on hardware of the computer 1000, and the like.

The HDD 1400 is a computer-readable recording medium that non-temporarily records programs executed by the CPU 1100, and data and the like used by the programs. Specifically, the HDD 1400 is a recording medium that records a program for executing each operation according to the present disclosure, which is an example of program data 1450.

The communication interface 1500 is an interface for the computer 1000 to connect to an external network 1550 (for example, the Internet). For example, the CPU 1100 receives data from another apparatus and transmits data generated by the CPU 1100 to another apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. The CPU 1100 also sends data to an output device such as a display, a speaker, a printer, or the like via the input/output interface 1600. The input/output interface 1600 may function as a media interface that reads a program or the like recorded in a predetermined recording medium (media). The medium is an optical recording medium such as a Digital Versatile Disc (DVD) or a Phase Change Rewritable Disk (PD), a magneto-optical recording medium such as a Magneto-Optical disk (MO), a tape medium, a magnetic recording medium, a semiconductor memory, or the like.

At least some of the functions of the measurement device 10, the PC 30, the server 90, and the like described above may be realized by, for example, the CPU 1100 of the computer 1000 executing a program loaded on the RAM 1200. The HDD 1400 stores a program and the like according to the present disclosure. Note that the CPU 1100 reads the program data 1450 from the HDD 1400 and executes the program data, but may acquire these programs from another device via the external network 1550, as another example.

### 13. Example of Effect

The technique described above is specified as follows, for example. One of the disclosed techniques is the measurement device 10 or the like. As described with reference to FIGS. 1 to 10 and the like, the measurement device 10 is a measurement device 10 for performing acoustic measurement, and includes one or more microphones 11 that acquire sound output from a sound source at the sound receiving point 11X, the first support 13 that directly or indirectly supports the one or more microphones 11 such that the sound receiving point 11X is located at the rotation center 12 or in the air at a predetermined distance from the rotation center 12, the second support 14 that supports the first support 13 at a lower end of the first support 13, a first motor 15 that rotates the first support 13 in a vertical direction, and a second motor 16 that rotates the second support 14 in a horizontal direction.

Thus, the measurement device 10 can locate the one or more microphones 11 at the rotation center 12 or at a plurality of points at a predetermined distance from the rotation center 12 by controlling the first support 13 and the second support 14. Since the sound receiving point 11X is supported in the air by the first support 13, the measurement device 10 can perform the acoustic measurement in a state where there is no structure such as the first support 13 that affects a measurement result of the acoustic measurement around the sound receiving point 11X. In this manner, the measurement device 10 can change the position and orientation of the microphone 11 with a high degree of freedom, and can suppress the influence of the structure on the acoustic measurement.

As described with reference to FIGS. 1 to 10, the rotation center 12 may be the intersection of the rotation axis of the first support 13 and the rotation axis of the second support 14. The measurement device 10 can locate the microphone 11 at the rotation center 12 or at a plurality of points at a certain distance from the rotation center 12 by controlling the first support 13 and the second support 14.

As described with reference to FIGS. 1 to 10 and the like, the first support 13 may directly or indirectly support the microphone 11 such that the sound receiving point 11X is located at the rotation center 12, and the first motor 15 may rotate the first support 13 in the vertical direction such that the position of the sound receiving point 11X is constant. Accordingly, the measurement device 10 can orient the microphone 11 in a plurality of orientations while locating the sound receiving point 11X at the rotation center 12. As a result, the measurement device 10 can perform the acoustic measurement under the same environment as in the case where the sound receiving point 11X is located on the surface of a virtual sphere that is spaced apart from the rotation center 12 by zero centimeters.

As described with reference to FIGS. 1 to 10 and the like, at least one of the first motor 15 or the second motor 16 may be installed at a position adjacent to the second support 14. Accordingly, the measurement device 10 can reduce the influence of noise caused by the operations of the first motor 15 and the second motor 16. The measurement device 10 can perform the acoustic measurement in a state where there is no structure that affects the result of the acoustic measurement around the sound receiving point 11X of the microphone 11.

As described with reference to FIGS. 1 to 10 and the like, the measurement device 10 may further include the measurement section 17 that measures the angle of the microphone 11. Accordingly, the measurement device 10 can adjust an error in the position of the microphone 11 caused by a power shortage in the first motor 15 or the second motor 16 or during the transmission of power, using the angle information on the angle of the microphone 11 measured by the measurement section 17 as feedback. The measurement device 10 can compensate for deterioration in the accuracy of the position where the microphone 11 is installed by driving these motors, and improve the accuracy of the position of the microphone 11.

As described with reference to FIGS. 1 to 10 and the like, the measurement device 10 may further include the third motor 19 that directly or indirectly drives the microphone 11 so that the distance from the rotation center 12 to the microphone 11 is variable. Accordingly, the measurement device 10 can perform the acoustic measurement under the same environment as in the case where the sound receiving points 11X are disposed on the surfaces of a plurality of virtual spheres having different distances from the rotation center 12. That is, the measurement device 10 can perform the acoustic measurement that provides measurement results of acoustic measurement according to a plurality of algorithms having different distances from the rotation center 12.

As described with reference to FIGS. 1 to 10 and the like, the microphone 11 may include a spherical array microphone in which a plurality of microphones 11 are installed in one housing. Since the microphone 11 includes a plurality of microphones 11, the measurement device 10 can acquire a plurality of positions and orientations of the sound receiving point 11X of the microphone 11 by one measurement, and thus it is possible to improve the time efficiency of the acoustic measurement. The measurement device 10 can change the position and orientation of the microphone 11 with a higher degree of freedom by using the microphone 11 including a compact spherical array microphone.

As described with reference to FIGS. 1 to 10 and the like, the measurement device 10 may further include the sensor 23 that detects the position of at least one of the microphone 11 or the measurement device 10. Accordingly, the measurement device 10 can improve the accuracy of the position of at least one of the microphone 11 or the measurement device 10. For example, the measurement device 10 includes the sensor 23 that detects the position of the microphone 11, and thus, it is possible to improve the accuracy of the position where the microphone 11 is installed, similarly to the case where the measurement device 10 includes the measurement section 17.

As described with reference to FIGS. 1 to 10 and the like, the measurement device 10 may further include the wheel 24 for moving the measurement device 10 below the second Support 14. Accordingly, the measurement device 10 can be moved by the wheel 24 to any point within the measurement environment and perform acoustic measurements at one or more measurement positions at that point.

As described with reference to FIGS. 1 to 10 and the like, the first support 13 may include a U-shaped support 13X, which is a U-shaped support 13X where the microphone 11 is directly or indirectly supported at the bottom of the U-shaped support 13X, and two columnar supports 13Y that lock the upper ends of the U-shaped support 13X in a state where the U-shaped support 13X is rotatable in accordance with the power transmitted from the first motor 15. The measurement device 10 can perform the acoustic measurement in a state where there is no structure around the sound receiving point 11X while the sound receiving point 11X is installed at the rotation center 12 or at a predetermined distance from the rotation center 12 by rotating the microphone 11 through the rotation of the first support 13.

As described with reference to FIGS. 1 to 10 and the like, the U-shaped support 13X may directly or indirectly support the microphone 11 at the bottom so that the distance between the sound receiving point 11X and each of the two columnar supports 13Y is equal to or greater than a predetermined threshold. Accordingly, the measurement device 10 can make the sound receiving point 11X less likely to be affected by the structure, such as reducing the influence of the reflection of the sound by the structure such as the two columnar supports 13Y on the sound receiving point 11X.

As described with reference to FIGS. 1 to 10 and the like, the shape of the first support 13 may be a circular shape or an arc shape. The measurement device 10 can also perform the acoustic measurement in a state where there is no structure around the sound receiving point 11X while the sound receiving point 11X is installed at the rotation center 12 or at a predetermined distance from the rotation center 12 by rotating the microphone 11 through the rotation of the first support 13.

The measurement system 1 and the like described with reference to FIGS. 11 to 19 and the like are also one of the disclosed techniques. The measurement system 1 is a measurement system 1 for performing an acoustic measurement, and includes the measurement device 10 and an information processing device (PC 30, audio interface 70, or the like), the measurement device 10 including one or more microphones 11 that acquire sound output from a sound source at the sound receiving point 11X, the first support 13 that directly or indirectly supports the one or more microphones 11 so that the sound receiving point 11X is located at the rotation center 12 or in the air at a predetermined distance from the rotation center 12, the second support 14 that supports the first support 13 at a lower end of the first support 13, the first motor 15 that rotates the first support 13 vertically, and the second motor 16 that rotates the second support 14 horizontally, the information processing device including an output control unit (audio interface 70) that causes the sound source 50 to output sound. According to the measurement system 1, the position and orientation of the microphone 11 can be changed with a high degree of freedom, and the influence of the structure on the acoustic measurement can be suppressed.

As described with reference to FIGS. 11 to 19 and the like, the measurement device 10 may further include the measurement section 17 that measures the angle of the microphone 11, and the information processing device may further include the motor control unit 323 that controls the rotation angle of the first support 13 by the first motor 15 and the rotation angle of the second support 14 by the second motor 16 based on the angle of the microphone 11 measured by the measurement section 17.

Accordingly, the measurement system 1 can adjust the error of the position of the microphone 11 caused by the power shortage of the first motor 15 and the second motor 16 or during power transmission, using the angle information on the angle of the microphone 11 measured by the measurement section 17 as feedback. The measurement system 1 can compensate for deterioration in the accuracy of the position where the microphone 11 is newly installed by driving these motors, and can improve the accuracy of the position of the microphone 11.

As described with reference to FIGS. 11 to 19 and the like, the information processing device may further include the setting section 322 that sets the measurement position, which is the position of the microphone 11 when the acoustic measurement is performed, and the determination section 324 that determines whether or not the acoustic measurement has been performed at at least one of the measurement position set by the setting section 322 or the position of the measurement device 10. Accordingly, the measurement system 1 can perform the acoustic measurement at at least one of the measurement position determined by the determination section 324 that the acoustic measurement has not been performed and the position of the measurement device 10, among at least one of the measurement position set by the setting section 322 or the position of the measurement device 10. The measurement system 1 can reduce erroneous acoustic measurement at at least one of the measurement position where the acoustic measurement has been performed or the position of the measurement device 10.

As described with reference to FIGS. 11 to 19 and the like, the information processing device may further include the display control unit 326 that causes the display section 33 to display the measurement position where the acoustic measurement has not been performed and the measurement position where the acoustic measurement has been performed in different display modes among the measurement positions set by the setting section 322. Accordingly, the measurement system 1 can cause the display section 33 to display the degree of the measurement positions at which the acoustic measurements have been performed among the measurement positions set by the setting section 322. The measurement system 1 can identify a measurement position where the acoustic measurement has not been performed and a measurement position where the acoustic measurement has been performed, and can reduce erroneous acoustic measurements performed by the measurement device 10 at the measurement position where the acoustic measurement has been performed.

As described with reference to FIGS. 11 to 19 and the like, the measurement device 10 may further include the wheel 24 that moves the measurement device 10 so that the microphone 11 is located at the measurement position, below the second support 14. Accordingly, the measurement system 1 can move the measurement device 10 to an arbitrary point in the measurement environment by the wheel 24 and perform the acoustic measurement at one or more measurement positions at the point.

As described with reference to FIGS. 11 to 19 and the like, the information processing device may further include the communication unit 37 that transmits the measurement information on the measurement result and the measurement condition of the acoustic measurement to the server 90 that can be accessed only by the subject authorized to use the measurement information. Accordingly, the measurement system 1 can cause the measurement information obtained by the acoustic measurement to be utilized by the subject authorized to use the measurement information.

As described with reference to FIGS. 11 to 19 and the like, the information processing device may further include the conversion section 327 that converts the format of the measurement information based on the measurement position, and the communication unit 37 may transmit the measurement information whose format has been converted by the conversion section 327 to the server 90. Accordingly, the measurement system 1 can transmit the measurement information converted into the format corresponding to the measurement position to the server 90.

As described with reference to FIGS. 11 to 19 and the like, the information processing device may further include the estimation section 328 that performs at least one of the first estimation of estimating the measurement result of the acoustic measurement at a position where the acoustic measurement has not been performed based on the measurement result of the acoustic measurement at one or more measurement positions or the second estimation of estimating the measurement result of the acoustic measurement when the sound source is installed at a position where the acoustic measurement has not been performed based on the measurement result of the acoustic measurement by one or more sound sources. Accordingly, when the first estimation has been performed, the information processing device can estimate the measurement result of the acoustic measurement at a desired position for the user of the information processing device. When the second estimation has been performed, the information processing device can estimate the measurement result of the acoustic measurement when the sound source is installed at a desired position for the user of the information processing device.

The effects described in the present disclosure are merely examples, and are not limited to the disclosed contents. Other effects may be present.

Each processing in the information processing device, the measurement device, and the server is not limited to the processing in each device described in the above embodiments, and may be performed by any device.

Although the embodiments of the present disclosure have been described above, the technical scope of the present disclosure is not limited to the above-described embodiments as they are, and various modifications can be made without departing from the gist of the present disclosure, and different components over the modified examples may be appropriately combined.

Note that the present technique may be related to goal 9, “Industry, innovation, infrastructure” of the Sustainable Development Goals (SDGs) adopted in the United Nations Summit in 2015.

Note that the present technique can also have the following configurations.
(1)

A measurement device for performing an acoustic measurement, including:
one or more microphones configured to acquire sound output from a sound source at a sound receiving point;
a first support which directly or indirectly supports the one or more microphones in such a manner that the sound receiving point is located at a rotation center or in the air at a predetermined distance from the rotation center;
a second support which supports the first support at a lower end of the first support;
a first motor configured to rotate the first support in a vertical direction; and
a second motor configured to rotate the second support in a horizontal direction.
(2)

The measurement device according to (1),
wherein the rotation center is an intersection of a rotation axis of the first motor and a rotation axis of the second motor.
(3)

The measurement device according to (1) or (2),
wherein the first support directly or indirectly supports the one or more microphones in such a manner that the sound receiving point is located at the rotation center, and
the first motor is configured to rotate the first support in a vertical direction in such a manner that a position of the sound receiving point is constant.
(4)

The measurement device according to any one of (1) to (3),
wherein at least one of the first motor or the second motor is installed at a position adjacent to the second support.
(5)

The measurement device according to any one of (1) to (4), further including a measurement section configured to measure an angle of the one or more microphones.
(6)

The measurement device according to any one of (1) to (5), further including a third motor configured to directly or indirectly drive the one or more microphones in such a manner that a distance from the rotation center to the one or more microphones is variable.
(7)

The measurement device according to any one of (1) to (6),
wherein the one or more microphones include a spherical array microphone in which a plurality of microphones are installed in one housing.
(8)

The measurement device according to any one of (1) to (7), further including a sensor configured to detect a position of at least one of the one or more microphones or the measurement device.
(9)

The measurement device according to any one of (1) to (8), further including a wheel which is provided below the second support and moves the measurement device.
(10)

The measurement device according to any one of (1) to (9),
wherein the first support includes:
a U-shaped support in which the one or more microphones are directly or indirectly supported at a bottom of the U-shaped support; and
two columnar supports that respectively lock upper ends of the U-shaped support in a state where the U-shaped support is rotatable in accordance with power transmitted from the first motor.
(11)

The measurement device according to (10),
wherein the U-shaped support directly or indirectly supports the one or more microphones at the bottom in such a manner that a distance between the sound receiving point and each of the two columnar supports is equal to or greater than a predetermined threshold.
(12)

The measurement device according to any one of (1) to (10),
wherein the first support has a circular shape or an arc shape.
(13)

A measurement system for performing an acoustic measurement, including:
a measurement device; and
an information processing device,
wherein the measurement device includes:
one or more microphones configured to acquire sound output from a sound source at a sound receiving point;
a first support which directly or indirectly supports the one or more microphones in such a manner that the sound receiving point is located at a rotation center or in the air at a predetermined distance from the rotation center;
a second support which supports the first support at a lower end of the first support;
a first motor configured to rotate the first support in a vertical direction; and
a second motor configured to rotate the second support in a horizontal direction, and
the information processing device includes an output control unit configured to cause the sound source to output the sound.
(14)

The measurement system according to (13),
wherein the measurement device further includes a measurement section configured to measure an angle of the one or more microphones, and
the information processing device further includes a motor control unit configured to control a rotation angle of the first support by the first motor and a rotation angle of the second support by the second motor based on the angle of the one or more microphones measured by the measurement section.
(15)

The measurement system according to (13) or (14),
wherein the information processing device further includes:
a setting section configured to set a measurement position which is a position of the one or more microphones when the acoustic measurement is performed; and
a determination section configured to determine whether or not the acoustic measurement has been performed at the measurement position set by the setting section.
(16)

The measurement system according to (15),
wherein the information processing device further includes a display control unit configured to cause a display section to display, in different display modes, a measurement position where the acoustic measurement has not been performed and a measurement position where the acoustic measurement has been performed by the determination section among the measurement positions set by the setting section.
(17)

The measurement system according to (15) or (16),
wherein the measurement device further includes a wheel which is provided below the second support and moves the measurement device in such a manner that the one or more microphones are located at the measurement position.
(18)

The measurement system according to any one of (15) to (17),
wherein the information processing device further includes a transmission section configured to transmit measurement information on a measurement result and a measurement condition of the acoustic measurement to a server which is accessible only by a subject authorized to use the measurement information.
(19)

The measurement system according to (18),
wherein the information processing device further includes a conversion section configured to convert a format of the measurement information based on the measurement position, and
the transmission section is configured to transmit the measurement information in which the format has been converted by the conversion section to the server.
(20)

The measurement system according to any one of (15) to (19),
wherein the information processing device further includes an estimation section configured to perform at least one of:
a first estimation of estimating a measurement result of the acoustic measurement at a position where the acoustic measurement has not been performed, based on a measurement result of the acoustic measurement at one or more of the measurement positions; or
a second estimation of estimating a measurement result of the acoustic measurement when the sound source is installed at a position where the acoustic measurement has not been performed, based on a measurement result of the acoustic measurement by one or more sound sources.

### REFERENCE SIGNS LIST

10 Measurement device
11 Microphone
11X Sound receiving point
12 Rotation center
13 First support
13X U-shaped support
13Y Columnar support
14 Second support
15 First motor
16 Second motor
17 Measurement section
18 Boom
19 Third motor
20 Columnar portion
21 Belt
22 Pedestal

1. A measurement device for performing an acoustic measurement, comprising:
one or more microphones configured to acquire sound output from a sound source at a sound receiving point;
a first support which directly or indirectly supports the one or more microphones in such a manner that the sound receiving point is located at a rotation center or in the air at a predetermined distance from the rotation center;
a second support which supports the first support at a lower end of the first support;
a first motor configured to rotate the first support in a vertical direction; and
a second motor configured to rotate the second support in a horizontal direction.

2. The measurement device according to claim 1, wherein the rotation center is an intersection of a rotation axis of the first support and a rotation axis of the second support.

3. The measurement device according to claim 1,
wherein the first support directly or indirectly supports the one or more microphones in such a manner that the sound receiving point is located at the rotation center, and
the first motor is configured to rotate the first support in a vertical direction in such a manner that a position of the sound receiving point is constant.

4. The measurement device according to claim 1,
wherein at least one of the first motor or the second motor is installed at a position adjacent to the second support.

5. The measurement device according to claim 1, further comprising a measurement section configured to measure an angle of the one or more microphones.

6. The measurement device according to claim 1, further comprising a third motor configured to directly or indirectly drive the one or more microphones in such a manner that a distance from the rotation center to the one or more microphones is variable.

7. The measurement device according to claim 1,
wherein the one or more microphones include a spherical array microphone in which a plurality of microphones are installed in one housing.

8. The measurement device according to claim 1, further comprising a sensor configured to detect a position of at least one of the one or more microphones or the measurement device.

9. The measurement device according to claim 1, further comprising a wheel which is provided below the second support and moves the measurement device.

10. The measurement device according to claim 1,
wherein the first support includes:
a U-shaped support in which the one or more microphones are directly or indirectly supported at a bottom of the U-shaped support ; and
two columnar supports that respectively lock upper ends of the U-shaped support in a state where the U-shaped support is rotatable in accordance with power transmitted from the first motor.

11. The measurement device according to claim 10,
wherein the U-shaped support directly or indirectly supports the one or more microphones at the bottom in such a manner that a distance between the sound receiving point and each of the two columnar supports is equal to or greater than a predetermined threshold.

12. The measurement device according to claim 1,
wherein the first support has a circular shape or an arc shape.

13. A measurement system for performing an acoustic measurement, comprising:
a measurement device; and
an information processing device,
wherein the measurement device includes:
one or more microphones configured to acquire sound output from a sound source at a sound receiving point;
a first support which directly or indirectly supports the one or more microphones in such a manner that the sound receiving point is located at a rotation center or in the air at a predetermined distance from the rotation center;
a second support which supports the first support at a lower end of the first support;
a first motor configured to rotate the first support in a vertical direction; and
a second motor configured to rotate the second support in a horizontal direction, and
the information processing device includes an output control unit configured to cause the sound source to output the sound.

14. The measurement system according to claim 13,
wherein the measurement device further includes a measurement section configured to measure an angle of the one or more microphones, and
the information processing device further includes a motor control unit configured to control a rotation angle of the first support by the first motor and a rotation angle of the second support by the second motor based on the angle of the one or more microphones measured by the measurement section.

15. The measurement system according to claim 13,
wherein the information processing device further includes:
a setting section configured to set at least one of a measurement position which is a position of the one or more microphones when the acoustic measurement is performed and a position of the measurement device; and
a determination section configured to determine whether or not the acoustic measurement has been performed at at least one of the measurement position or the position of the measurement device set by the setting section.

16. The measurement system according to claim 15,
wherein the information processing device further includes a display control unit configured to cause a display section to display, in different display modes, a measurement position where the acoustic measurement has not been performed and a measurement position where the acoustic measurement has been performed among the measurement positions set by the setting section.

17. The measurement system according to claim 15
wherein the measurement device further includes a wheel which is provided below the second support and moves the measurement device in such a manner that the one or more microphones are located at the measurement position.

18. The measurement system according to claim 15,
wherein the information processing device further includes a transmission section configured to transmit measurement information on a measurement result and a measurement condition of the acoustic measurement to a server which is accessible only by a subject authorized to use the measurement information.

19. The measurement system according to claim 18,
wherein the information processing device further includes a conversion section configured to convert a format of the measurement information based on the measurement position, and
the transmission section is configured to transmit the measurement information in which the format has been converted by the conversion section to the server.

20. The measurement system according to claim 15,
wherein the information processing device further includes an estimation section configured to perform at least one of:
a first estimation of estimating a measurement result of the acoustic measurement at a position where the acoustic measurement has not been performed, based on a measurement result of the acoustic measurement at one or more of the measurement positions; or
a second estimation of estimating a measurement result of the acoustic measurement when the sound source is installed at a position where the acoustic measurement has not been performed, based on a measurement result of the acoustic measurement by one or more sound sources.
